(19) United States
(12) Patent Application Publication
(10) Pub. No.: US 2005/0142345 A1
(43) Pub. Date: Jun. 30, 2005

(54) Curing processes for substrate imprinting, structures made thereby, and polymers used therefor

(76) Inventor: Saikumar Jayaraman, Chandler, AZ (US)

Correspondence Address: SCHWEGMAN, LUNDBERG, WOESSNER & KLUTH, P.A., P.O. BOX 2938, MINNEAPOLIS, MN, 55402-0938, US

(21) Appl. No.: 10/751,270

(22) Filed: Dec. 30, 2003

(51) Int. Cl. B32B 7/02

(52) U.S. Cl. 428/216

(57) ABSTRACT

A mounting substrate includes an at least double-embossed structure on one side for containing metallization traces. The mounting substrate is overlaid with an uncured polymer and it is imprinted and cured by infrared or microwave energy. A second uncured polymer is placed over the cured polymer first film. It is imprinted and also cured under conditions that allow retention of significant features of the cured polymer first film. A chip package is also made of the double-embossed structure. The chip package can include a heat sink. A computing system is also disclosed that includes the double-embossed structure.

### TECHNICAL FIELD

Disclosed embodiments relate to imprinting above a substrate for mounting a microelectronic device on the substrate. Embodiments include multiple-layer imprinted structures.

### BACKGROUND INFORMATION

### DESCRIPTION OF RELATED ART

Various techniques have been tried to prepare imprinted substrates such as printed wiring boards (PWBs). As metallization becomes more complex due to miniaturization, stacked metal traces in PWBs have become necessary in order to pin out all electrical contacts. Liquid crystal polymers (LCPs) have been cured by convection heating for various uses including substrate imprinting. A drawback for imprinting LCPs is the inability to stack them. This drawback arises due to the very high processing temperatures required for LCPs and also due to low degree of crosslinks in the polymers. Consequently for multi-layer PWBs, melting or softening of the first layer occurs as the second layer is processed. Also high molecular weight LCPs can have unacceptable adhesion to metals used for substrates.

Low molecular weight polymers have been used to overcome some of the problems in high molecular weight LCPs. Typical processing temperatures for low molecular weight polymers include 160-180° C. for 1-2 minutes (min) at imprinting, followed by a post cure around 175° C. for 60-120 min. Under the current imprinting conditions, the epoxy films that have been used are expected not to cure completely. Hence post cure of these films is desired for full mechanical property build-up. But a post cure process uses convection ovens that heat the entire structure. In convectional heating, the process time is controlled by the rate at which heat flows into the material from the heated surfaces. This highly depends on the viscosity of the material, density of the material, and thermal conductivity of the material. Although the viscosity of the material is low, the density and poor thermal conductivity of the materials makes the convectional process very long. Due to low molecular weight nature of these materials, lower cure completion during imprinting, and the long cure time during post cure processing, result in the features either being deformed or distorted due to flow of the material, even at the post cure temperatures. Further, the use of long cure time at the post cure stage leads to batch processing, long process times, and low output.

### BRIEF DESCRIPTION OF THE DRAWINGS

In order to understand the manner in which embodiments are obtained, a more particular description of various embodiments briefly described above will be rendered by reference to the appended drawings. These drawings depict embodiments that are not necessarily drawn to scale and are not to be considered to be limiting in scope. Some embodiments will be described and explained with additional specificity and detail through the use of the accompanying drawings in which:

FIG. 1 is a cross-section of a structure according to an embodiment;

FIG. 1A is a cross-section of the structure depicted in FIG. 1 during processing according to an embodiment;

FIG. 1B is a cross-section of the structure depicted in FIG. 1A after further processing;

FIG. 1C is a cross-section of the structure depicted in FIG. 1B after further processing;

FIG. 1D is a cross-section of the structure depicted in FIG. 1C after further processing;

FIG. 1E is a cross-section of the structure depicted in FIG. 1D after further processing;

FIG. 1F is a cross-section of the structure depicted in FIG. 1E after further processing;

FIG. 1G is a cross-section of the structure depicted in FIG. 1F after further processing;

FIG. 2 is an elevation taken from a section in FIG. 1C according to an embodiment;

FIG. 3 is an elevation taken from a section in FIG. 1C according to an embodiment;

FIG. 4 is a cross-section of a structure according to an embodiment;

FIG. 5 is a process flow diagram that illustrates various exemplary process embodiments that relate to FIGS. 1-4;

FIG. 6 is a cross-section of a package that includes a memory module according to an embodiment;

FIG. 7 is a cross-section of a package that includes a double-embossed structure according to an embodiment;

FIG. 8 is a cross-section of a chip package that includes a heat sink according to an embodiment; and

FIG. 9 is a depiction of a computing system according to an embodiment.

### DETAILED DESCRIPTION

The following description includes terms, such as upper, lower, first, second, etc. that are used for descriptive purposes only and are not to be construed as limiting. The embodiments of a device or article described herein can be manufactured, used, or shipped in a number of positions and orientations. The terms “die” and “processor” generally refer to the physical object that is the basic workpiece that is transformed by various process operations into the desired integrated circuit device. A board is typically a conductor-overlay structure that is insulated and that acts as a mounting substrate for the die. A board is usually singulated from an board array. A die is usually singulated from a wafer, and wafers may be made of semiconducting, non-semiconducting, or combinations of semiconducting and non-semiconducting materials.

Reference will now be made to the drawings wherein like structures will be provided with like reference designations. In order to show the structure and process embodiments most clearly, the drawings included herein are diagrammatic representations of embodiments. Thus, the actual appearance of the fabricated structures, for example in a photomicrograph, may appear different while still incorporating the essential structures of embodiments. Moreover, the drawings show only the structures necessary to understand the embodiments. The embodiment may be referred to, individually and/or collectively, herein by the term, “invention” merely for convenience and with intending to voluntarily limit the scope of this application to any single invention or inventive concept if more than one is in fact disclosed. Additional structures known in the art have not been included to maintain the clarity of the drawings.

Disclosed embodiments relate to a multi-layer imprinting process flow that reduces pattern loss during processing of a subsequent layer.

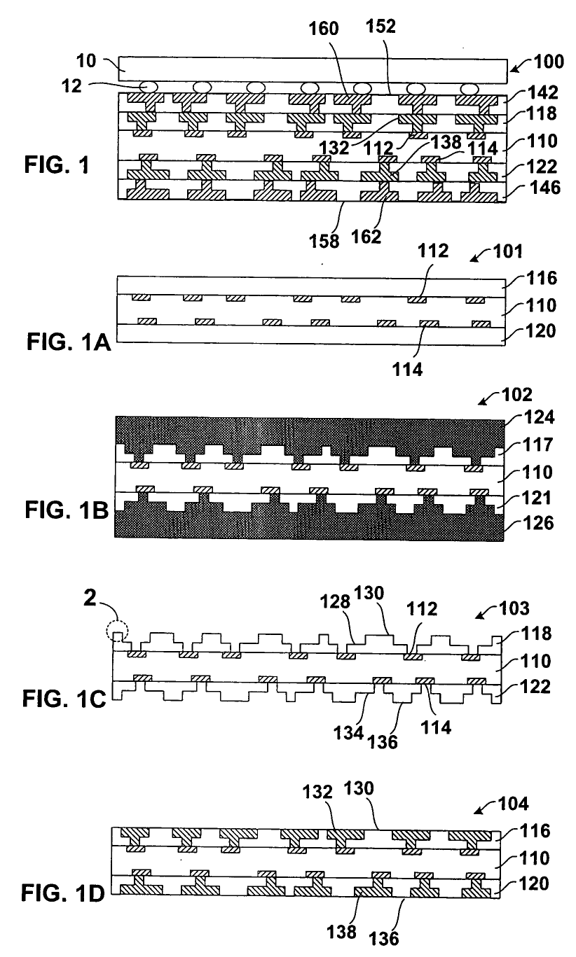

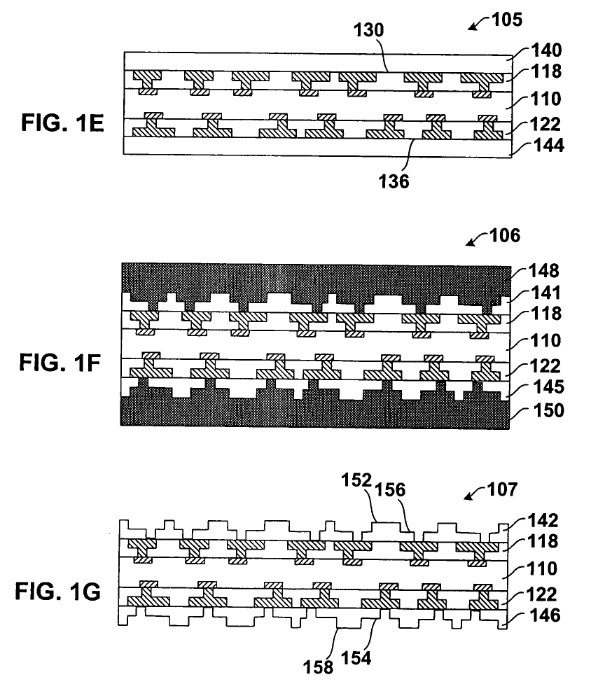

FIG. 1 is a cross-section of a double-embossed structure 100 according to an embodiment. The structure 100 includes a substrate 110, which is a substrate for mounting a microelectronic device according to an embodiment. In an embodiment, the substrate 110 is part of a printed wiring board (PWB) such as a main board. In an embodiment, the substrate 110 is part of a mezzanine PWB. In an embodiment, the substrate 110 is part of an expansion card PWB. In an embodiment, the substrate 110 is part of a small PWB such as a board for a handheld device such as a cell phone or a personal digital assistant (PDA).

In an embodiment, the substrate 110 includes an upper contact pad 112 for electrical coupling with a microelectronic device. A cured polymer upper first film 118 includes an upper first topology 128 (FIG. 1C) that is filled in with an upper first metallization 132. The upper first metallization 132 shares an upper surface with an upper surface 130 (FIG. 1C) of the cured polymer upper first film 118.

The upper first metallization 132 is at least partially surmounted with a cured polymer upper second film 142. The cured polymer upper second film 142 includes an upper second topology 156 (FIG. 1G) that is filled in with an upper second metallization 160. The upper second metallization 160 shares an upper surface with a second upper surface 152 of the cured polymer upper second film 142.

In an embodiment, the package 100 includes a lower structure that can be similar generally to the upper structures. The substrate 110 includes a lower contact pad 114 for electrical coupling with a microelectronic device. A cured polymer lower first film 122 includes a lower first topology 134 (FIG. 1C) that is filled in with a lower first metallization 138. The lower first metallization 138 shares a lower surface with a first lower surface 136 (FIG. 1C) of the cured polymer lower first film 122. The lower first metallization 138 is at least partially surmounted with a cured polymer lower second film 146. The cured polymer lower second film 146 includes a second topology 154 (FIG. 1G) that is filled in with a lower second metallization 162. The lower second metallization 162 shares a lower surface with a second lower surface 158 of the cured polymer lower second film 146.

In an embodiment, the first metallization has a thickness range from about 0.1 μm to about 100 μm. In an embodiment, the first metallization has a thickness range from about 0.5 μm to about 50 μm. In an embodiment, the second metallization has a thickness range from about 1 μm to about 20 μm. In an embodiment, the second metallization has a thickness range from about 2 μm to about 10 μm.

FIG. 1 also illustrates a microelectronic device 10 mounted and electrically coupled to the structure 100. By way of non-limiting example, the device 10 is mounted in a flip-chip orientation upon the upper second metallization 160 by a series of electrical bumps 12, one of which is delineated. In an embodiment, the device 10 is wire bonded (not pictured) to the upper second metallization 160 in a non flip-chip orientation. In an embodiment, the device 10 coupled to the structure 100 represents a portion of a computing system.

FIG. 1A is a cross-section of the structure 101 depicted in FIG. 1 during processing according to an embodiment. The substrate 110 and the contact pads 112 and 114 have been covered with an uncured polymer mass. In an embodiment, an uncured upper first polymer 116 and an uncured lower first polymer 120 are disposed over the substrate 110. In an embodiment, the uncured first polymers include high molecular weight compositions.

In an embodiment, a pre-curing process is carried out on the respective uncured upper and lower first polymers 116 and 120, to partially stiffen them in preparation for a first imprinting. Accordingly, the respective uncured upper and lower first polymers 116 and 120 have a pre-process glass transition temperature (T_{G}) before the pre-curing, a post-imprint T_{G} after imprinting, and a first T_{G} after final curing.

FIG. 1B is a cross-section of the structure 101 depicted in FIG. 1A during further processing. The structure 102 is in the process of being imprinted. In an embodiment, an upper imprinting press 124 is articulated against the uncured upper first polymer 116 (FIG. 1A) to form an intermediate upper first polymer 117, particularly in regions contiguous with the upper imprinting press 124. Conductive heat transfer is applied through the upper imprinting press 124 to achieve a post-imprint T_{G} in the intermediate upper first polymer 117. In an embodiment, the post-imprint T_{G} is about 75° C. above the pre-process T_{G}. Similarly in an embodiment, a lower imprinting press 126 is articulated against the uncured lower first polymer 120 (FIG. 1A) to form an intermediate lower first polymer 121 with a post-imprint T_{G} of about 75° C. above the pre-process T_{G}.

FIG. 1C is a cross-section of the structure 102 depicted in FIG. 1B after further processing according to an embodiment. The structure 103 is in the process of a first cure. After removal of the upper imprinting press 124, the intermediate upper first polymer 117 (FIG. 1B) exhibits an upper first topology 128 including the first upper surface 130. In FIG. 1C, the reference number, which refers to the first topology 128, is touching within a recess in the topology. Similarly after removal of the lower imprinting press 126, the intermediate lower first polymer 121 (FIG. 1B) exhibits a lower first topology 134 including a first lower surface 136. In FIG. 1C, the reference number, which refers to the first topology 134, is touching within a recess in the topology 134.

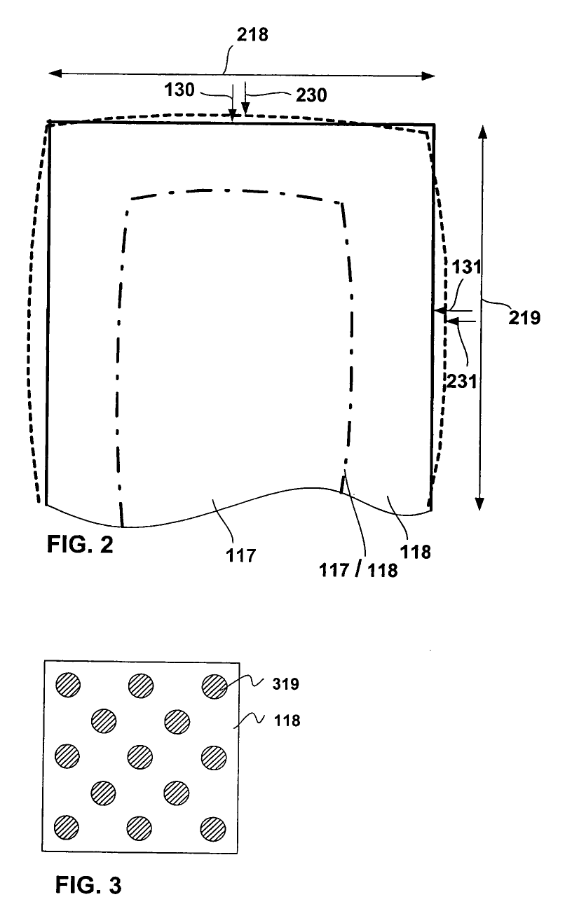

FIG. 2 is an elevation taken from the section 2 in FIG. 1C according to an embodiment. The section 2 illustrates the polymer mass that includes the intermediate upper first polymer 117. In an embodiment, conductive heating from the upper imprinting press 124, creates a structural gradient in the polymer mass. The intermediate upper first polymer 117 remains in the center of the polymer mass, and the cured polymer upper first film 118 is formed in part at the surface of the polymer mass. A boundary 117/118, depicted in arbitrary shape and size, represents a gradient between the cured polymer upper first film 118 and the intermediate upper first polymer 117. In an embodiment, the intermediate upper first polymer 117 is of negligible size after the heated imprinting. In an embodiment, the intermediate upper first polymer 117 is not existent within a minimum feature. In an embodiment, the intermediate upper first polymer 117 is not existent within a minimum feature, but it is still present in features that are larger than the minimum feature.

Referring again to FIG. 1C, the structure 103 is cured by at least one of IR or microwave heating. Because of the molecular level of heating instead of gross convectional heating, any deviation from planarity of the cured polymer upper first film 118 is minimized. For the first upper surface 130, the deviation from planarity includes a measurement of the highest (or lowest) point 230 of the cured polymer upper first film 118 as it has deviated from the original first upper surface 130 before the curing process. The deviation from planarity can be quantified by comparison of the profile of the upper imprinting press 124 and the profile of the cured polymer upper first film 118. Because the first upper topology 128 varies in upper surface lengths across the surface of the cured polymer upper first film 118, a convention is selected by which to quantify the deviation from planarity. According to the selected convention, the deviation from planarity is quantified across a smallest feature 218 of the cured polymer upper first film 118, such as the portion of the cured polymer upper first film 118 that is within the section line 2 as depicted in FIG. 1C.

In an embodiment, the deviation from planarity is quantified by the surface length 218 of the first upper surface 130. A cured first upper surface 230 deviates from the first upper surface 130, and it is quantified by dividing the smallest feature length 218 into the measured difference between first upper surface 130 and the cured first upper surface 230. In an embodiment, the deviation is determined by a scanning electron microscope technique. In an embodiment, the deviation is from about 0.001 percent to about 10 percent. In an embodiment, the deviation is from about 0.01 percent to about 1 percent. In an embodiment, the deviation is about 0.1 percent. In another quantification method, the maximum feature length in the topology 128 is used for the same technique. In this embodiment, the deviation is from about 0.001 percent to about 10 percent. In an embodiment, the deviation is from about 0.01 percent to about 1 percent. In an embodiment, the deviation is about 0.1 percent.

In an embodiment, the deviation from planarity is quantified from a first lateral surface 131. A cured first lateral surface 231 deviates from the first lateral surface 131, and it is quantified by dividing the deviation distance by the original feature height 219. In this quantification technique, the original feature height 219 is the minimum feature height in the cured polymer upper first film 118. In an embodiment, the deviation is from about 0.001 percent to about 10 percent. In an embodiment, the deviation is from about 0.01 percent to about 1 percent. In an embodiment, the deviation is about 0.1 percent. In another quantification method, the maximum feature height is used for the same technique. In this embodiment, the deviation is from about 0.001 percent to about 10 percent. In an embodiment, the deviation is from about 0.01 percent to about 1 percent. In an embodiment, the deviation is about 0.1 percent.

In an embodiment, processing of the intermediate polymer mass 117, 117/118 and 118 (FIG. 2) is carried out by an infrared (IR) heating. In an embodiment, the IR heating is configured to substantially heat the intermediate polymer mass 117, 117/118 and 118 without significant heating of the substrate 110. In an embodiment, the IR spectrum that is used includes a wavelength range from about 0.5 micrometer (μm) to about 3 μm. In an embodiment, the IR spectrum that is used includes a wavelength range from about 1 μm to about 2 μm. In an embodiment, an infrared furnace is used that is capable of achieving a temperature in a targeted polymer of from about 300° C. to about 1,300° C. Such furnaces are available commercially, including near-infrared, mid-range infrared furnaces, and others. In an embodiment, the infrared heating process achieves a temperature above about 50° C. or higher than the T_{G} of the uncured first polymer. In an embodiment, the infrared heating process achieves a temperature above about 75° C. or higher than the T_{G} of the uncured first polymer.

In an embodiment, processing of the intermediate polymer mass 117, 117/118 and 118 is carried out by microwave heating. In an embodiment, the microwave heating is configured to substantially heat the intermediate polymer mass 117, 117/118 and 118, without significant heating of the substrate 110. In an embodiment, the microwave heating process achieves a temperature above about 50° C. or higher than the T_{G} of the uncured polymer. In an embodiment, the microwave heating process achieves a temperature above about 75° C. or higher than the T_{G} of the uncured polymer.

The targeted heating of intermediate first polymers, with avoidance in significant heating of other structures, is achieved by molecular excitation of the intermediate polymer mass 117, 117/118 and 118 in contrast to gross convectional heating of the entire structure 103. Consequently, in either the IR or the microwave heating, the cured polymer upper first film 118 and the cured polymer lower first film 122 are achieved by thermal action that avoids general heating of the structure 103. The targeted heating allows for faster processing than gross convectional heating of the entire structure 103.

In an embodiment, an intermediate structure 103 exists in transient form during processing. The intermediate structure 103 includes the intermediate polymer mass 117, 117/118 and 118, in a first temperature range, and the substrate 110 at a second temperature range that is less than the first temperature range. This intermediate structure 103 is achieved during processing to cure the first polymer films 118 and 122 without gross convectional heating of the entire structure 103.

FIG. 1D is a cross-section of the structure 103 depicted in FIG. 1C after further processing. The structure 104 is depicted after a metallization process. A first conductive material acts as an upper first metallization 132. The upper first metallization 132 is formed within the upper first topology 128. In an embodiment, the upper first metallization 132 is formed by a blanket deposition of a metal, followed by planarization that removes excess metal to the level of the upper surface 130. Similarly, a lower first metallization 138 is formed within the lower first topology 134. In an embodiment, the lower first metallization 138 is formed by a blanket deposition of a metal, followed by planarization that removes excess metal to the level of the first lower surface 136.

FIG. 1E is a cross-section of the structure 104 depicted in FIG. 1D after further processing. The structure 105 is in the process of being overlaid with an uncured second polymer mass. The first upper and first lower surfaces 130 and 136, respectively, are covered by respective uncured upper and lower second polymers 140 and 144. In an embodiment, the uncured upper second polymer 140 and the uncured lower second polymer 144 are disposed over the substrate 110 by a screen printing process. In an embodiment, the uncured upper second polymer 140 and the uncured lower second polymer 144 are disposed over the substrate 110 by a spin-on coating process. In an embodiment, the uncured second polymers 140 and 144 include high molecular weight compositions.

In an embodiment, a pre-curing process is carried out on the respective uncured upper and lower second polymers 140 and 144, to partially stiffen them in preparation for a second imprinting. Accordingly, the respective upper and lower second polymers 140 and 144 have a pre-process T_{G} before the pre-curing, and a second T_{G} before final curing.

FIG. 1F is a cross-section of the structure 105 depicted in FIG. 1E during further processing. The structure 106 is in the process of being imprinted. In an embodiment, an upper imprinting press 148 is articulated against the uncured upper second polymer 140 (FIG. 1A) to form an intermediate upper second polymer 141. Conductive heat transfer is applied through the upper imprinting press 148 to achieve a post-imprint T_{G} in the intermediate upper second polymer 141. In an embodiment, the post-imprint T_{G} is about 75° C. above the pre-process T_{G}.

Similarly in an embodiment, a heated lower second imprinting press 150 is articulated against the uncured lower second polymer 144 (FIG. 1E) to form an intermediate lower second polymer 145. Conductive heat transfer is applied through the lower second imprinting press 150 to achieve a post-imprint T_{G} in the intermediate lower second polymer 145. In an embodiment, the post-imprint T_{G} is about 75° C. above the pre-process T_{G}.

FIG. 1G is a cross-section of the structure 106 depicted in FIG. 1F after further processing. The structure 107 is in the process of a second cure. During heated imprinting, an intermediate polymer mass is present as a transient structure, similar to the intermediate polymer mass 117, 117/118 and 118 depicted in FIG. 2. After removal of the upper second imprinting press 148, the intermediate upper second polymer 141 (FIG. 1F) exhibits an upper second topology 156 including a second upper surface 152. The reference line 156 touches the second topology 156 in a recess. Similarly after removal of the lower second imprinting press 150, the intermediate lower second polymer 145 (FIG. 1F) exhibits a lower second topology 154 including a second lower surface 158. The reference line 154 touches the second topology 154 in a recess.

In an embodiment, processing of the intermediate upper second polymer 141 and the intermediate lower second polymer 145 is carried out by IR heating. In an embodiment, the IR heating is configured to substantially heat the intermediate upper second polymer 141 and the intermediate lower second polymer 145, without significant heating of the substrate 110. In an embodiment, processing of the intermediate upper second polymer 141 and the intermediate lower second polymer 145 is carried out by microwave heating. In an embodiment, the microwave heating is configured to substantially heat the intermediate upper second polymer 141 and the intermediate lower second polymer 145, without significant heating of the substrate 110. Consequently, in either the IR or the microwave heating, the cured polymer upper second film 142 and the cured polymer lower second film 146 are cured by thermal action that avoids general heating of the structure 107, particularly of the substrate 110.

In an embodiment, an intermediate structure 106 (FIG. 1F) includes the cured polymer upper and lower first films 118 and 122, respectively, include the first T_{G}, and the intermediate upper and lower second polymers 141 and 145, respectively, include the second T_{G} that is lower than the first T_{G}. This intermediate structure 106 is in a transient temperature state due to processing operations. Accordingly in an embodiment, IR and/or microwave second curing is carried out above the second T_{G}, but second curing can be below the first T_{G}. Consequently during second curing, distinct patterning is substantially retained for the cured polymer upper and lower first films 118 and 122, respectively. In an embodiment, no deviation from planarity is detectible at a 2-power magnification. In an embodiment, no deviation from planarity is detectible at a 10-power magnification. In an embodiment, no deviation from planarity is detectible at a 100-power magnification. In an embodiment, no deviation from planarity is detectible at a 1,000-power magnification.

In an embodiment, an intermediate structure 107 also includes cured polymer upper and lower first films 118 and 122, respectively, at a first temperature, the substrate 110 at a substrate temperature, and the cured polymer upper and lower second films 142 and 146, respectively, at a second temperature. Because the cured polymer upper and lower first films 118 and 122, respectively, are substantially cyclized and are at a thermal equilibrium that is related to the curing energy used to second cure the intermediate upper and lower second polymers 141 and 145, respectively, the second temperature is greater than the first temperature, and the substrate temperature is also less than the second temperature. Consequently, thermal soaking of the structure 107 is minimized in the substrate 110, while thermal curing energy is primarily focused upon curing uncured and/or intermediate polymers.

Referring again to FIG. 1, substrate structure 100 represents the substrate structure 107 shown in FIG. 1G after further processing according to an embodiment. A second conductive material is used to form an upper second metallization 160 that is formed within the upper topology 156 (FIG. 1G). In an embodiment, the upper second metallization 160 is formed by a blanket deposition. In an embodiment, the upper second metallization 160 is formed by an electroless plating of a metal. If necessary, the deposition is followed by planarization that removes excess metal to the level of the second upper surface 152. Similarly, a lower second metallization 162 is formed within the lower topology 154 (FIG. 1G). In an embodiment, the lower second metallization 162 is formed by a blanket deposition or an electroless plating of a metal, followed by planarization if necessary.

Reference is again made to FIG. 1. Plating for both the first metallizations 132 and 138, and the second metallizations 160 and 162, can be carried out by a number of processes. In an embodiment, the metallization is generically referred to as a copper metallization, but the metallization can be formed of other conductors such as aluminum, silver, and others.

In an embodiment, the copper metallization is formed by a deposition process flow that includes electroless plating. In an embodiment, an alloying additive/dopant metal with the copper metallization includes a metal selected from silver (Ag), gold (Au), platinum (Pt), and combinations thereof. In an embodiment, an alloying additive metal with the copper metallization includes a metal selected from nickel (Ni), palladium (Pd), platinum (Pt), and combinations thereof. In an embodiment, an alloying additive metal with the copper metallization includes a metal selected from cobalt (Co), rhodium (Rh), iridium (Ir), and combinations thereof.

One property embodiment is that the cured polymer films exhibit sufficient adhesion to the substrate and/or the copper metallization that liftoff or spalling thereof will not occur during fabrication, test, and ordinary field use.

In an embodiment, the copper metallization includes an additive/dopant that is selected from nickel, palladium, cobalt, tungsten, chromium, titanium, ti-tungsten (TiW), zirconium, haffium, and the like. In an embodiment, the additive/dopant is supplied with the electroless plating solution in a concentration range from about 0.01 gram/liter to about 2 gram/liter. In an embodiment, the additive/dopant is supplied in a concentration range from about 0.05 gram/liter to about 1 gram/liter.

One feature of electroless plating of the copper metallization is that, due to chemically-induced oxidation-reduction reaction that is carried out only at chemically enabled sites, no post-deposition patterning and etching need to be done. Another feature of electroless plating of the copper metallization is that no bus bars are needed to impose cathodic behavior to the substrate 110. Consequently, there is no need for a bus bar structure, which would otherwise be susceptible to corrosion at the edge of the structure 100. Another feature of electroless plating of the copper metallization is, because no bus bars are needed to impose cathodic behavior to the substrate 110, in situ testing is possible for a board that has not been singulated from a board layout array.

According to an embodiment, the substrate 110 is immersed in a bath that contains one or more metal ions, and reduction of the ions occurs at the exposed portion of the substrate 110 at the metal pads 112 and 114 to form the copper metallization.

The metal ion or ions that are used to form the copper metallization may be selected from various metals or combinations as set forth above. In an embodiment, the copper is supplied in a concentration range from about 2 gram/liter to about 50 gram/liter. In an embodiment, the copper is supplied in a concentration range from about 5 gram/liter to about 35 gram/liter.

In an embodiment, reducing agents are provided to assist in assuring metal deposition of the copper metallization. The reducing agents are used because the chemical environment of the substrate onto which the metal deposits continues to change. In an embodiment, initial deposition of a metal ion onto the pads 112 and 114 may be autocatalytic.

In an embodiment, the electroless plating composition is combined with from zero to at least one primary reducing agent in a mixture of solvents. In an embodiment, a primary reducing agent including boron (B) is provided. Primary reducing agents that can be utilized for this application include ammonium agents, alkali metal agents, alkaline earth metal borohydride agents, and the like, and combinations thereof. In an embodiment, inorganic primary reducing agent embodiments include sodium borohydride, lithium borohydride, zinc borohydride, and the like, and combinations thereof. In an embodiment, an organic primary reducing agent is dimethylaminoborane (DMAB). In an embodiment, other aminoboranes are used such as diethylaminoborane, morpholine borane, combinations thereof, and the like. In an embodiment, the primary reducing agent(s) is supplied in a concentration range from about 1 gram/liter to about 30 gram/liter. In an embodiment, the primary reducing agent(s) is supplied in a concentration range from about 2 gram/liter to about 20 gram/liter.

In an embodiment, a secondary reducing agent is provided to assist the changing chemical environment during deposition of the primary metal and optional secondary metal. However, the secondary reducing agent may be used alone, without the primary reducing agent. In an embodiment a phosphorus-containing compound is selected as the secondary reducing agent. Phosphorus-containing compounds may include hypophosphites. In an embodiment, the hypophosphite is selected from organic hypophosphites such as ammonium hypophosphite and the like.

In an embodiment, the hypophosphite is selected from inorganic hypophosphites such as sodium hypophosphite and the like. One embodiment includes an inorganic phosphorus-containing compound such as hypophosphites of lithium, sodium, potassium, and mixtures thereof. One embodiment includes an inorganic phosphorus-containing compound such as hypophosphites of magnesium, calcium, strontium, and mixtures thereof. One embodiment includes an inorganic phosphorus-containing compound such as nickel hypophosphite and the like. One embodiment includes an inorganic phosphorus-containing compound such as hypophosphorous acid and the like.

Other secondary reducing agents are selected from sulfites, bisulfites, hydrosulfites, metabisulfites, and the like. Other secondary reducing agents are selected from dithionates, and tetrathionates, and the like. Other secondary reducing agents are selected from thiosulfates, thioureas, and the like. Other secondary reducing agents are selected from hydrazines, hydroxylamines, aldehydes, glyoxylic acid, and reducing sugars. In an embodiment, the secondary reducing agent is selected from diisobutylaluminum hydride, sodium bis(2-methoxyethoxy)aluminum hydride, and the like.

In an embodiment, the secondary reducing agent(s) is supplied in a concentration range from about 0 gram/liter to about 5 gram/liter. In an embodiment, the secondary reducing agent(s) is supplied in a concentration range from about 1 gram/liter to about 2 gram/liter.

In an embodiment, the primary reducing agent is DMAB in a concentration range from about 1 gram/liter to about 30 gram/liter, and the secondary reducing agent is ammonium hypophosphite in a concentration range from about 0 gram/liter to about 2 gram/liter. Other embodiments include primary and secondary reducing agents that are substituted for DMAB and ammonium hypophosphite, or one of them, as long as they approximate the gram equivalent amounts of the primary and secondary reducing agents of the DMAB and the ammonium hypophosphite. The gram equivalent amounts may be adjusted by various ways, such as according to the comparative dissociation constants of the reducing agents.

In addition to the reducing agents, other agents may be added such as alkaline metal-free chelating agents. Embodiments of chelating agents include citric acid, ammonium chloride, glycine, acetic acid, malonic acid, and the like in concentration range from about 5 gram/liter to about 70 gram/liter.

A complexing agent and a buffering agent are also used to hold the metal ion(s) in solution until deposition is appropriate. In an embodiment, an organic sulfate salt compound is used such as ammonium sulfate, (NH)₂SO₄ and the like. Other complexing and buffering agents may be selected that have an effective gram equivalent amount to the (NH)₂SO₄ such as copper sulfate, CuSO₄. In an embodiment, the complexing/buffering agent is supplied in a concentration range from about 50 gram/liter to about 1,000 gram/liter. In an embodiment, the complexing/buffering agent is supplied in a concentration range from about 80 gram/liter to about 600 gram/liter.

Various pH-adjusting compositions may be used including organic and inorganic bases. That a compound is basic can be easily confirmed by dipping pH test paper, measuring its aqueous solution using a pH meter, observing the discoloration caused by an indicator or measuring the adsorption of carbonic acid gas, and by other methods.

In an embodiment, the organic base compounds that can be used include organic amines such as pyridine, pyrrolidine, combinations thereof, and the like. Other embodiments include methylamine, dimethylamine, trimethylamine, combinations thereof, and the like. Other embodiments include ethylamine, diethylamine, triethylamine, combinations thereof, and the like. Other embodiments include tetramethylammonium hydroxide (TMAH), tetraethyl ammonium hydroxide (TEAH), tetrapropyl ammonium hydroxide (TPAH), tetrabutyl ammonium hydroxide (TBAH), combinations thereof, and the like. Other embodiments include aniline, toluidine, and the like.

In an embodiment, the organic base includes TMAH in a concentration range from about 30 mL to about 150 mL, added to a 100 mL volume of the other constituents of the electroless plating solution. Other embodiments include the gram equivalent amounts of the organic base compounds set forth herein.

In an embodiment, the inorganic base compounds that can be used are salts of strong bases and weak acids. In an embodiment, alkali metal acetates, alkaline earth metal acetates, and combinations thereof are used. In an embodiment, alkali metal propionates, alkaline earth metal propionates, and combinations thereof are used. In an embodiment, alkali metal carbonates, alkaline earth metal carbonates, and combinations thereof are used. In an embodiment, alkali metal hydroxides, alkaline earth metal hydroxides, and combinations thereof are used. In an embodiment, combinations of at least two of the acetates, propionates, carbonates, and hydroxides are used.

Inorganic base compounds may be provided in a concentration such as a 25% sodium hydroxide (NaOH) in a deionized (DI) water solution, to make a volume of about 10 mL to about 50 mL. This volume of solution is added to an about 100 mL volume of the other electroless plating composition constituents. Other embodiments include the gram equivalent amounts of the inorganic base compounds set forth herein.

Other compounds may be added to the electroless plating composition such as surface active agents. One commercial surfactant is RHODAFAC RE 610, made by Aventis (formerly Rhone-Poulenc Hoechst). Another commercial surfactant is Triton x-100T™ made by Sigma-Aldrich. Other surfactants include cystine, polyethylene glycols, polypropylene glycol (PPG)/polyethylene glycol (PEG) (in a molecular range of approximately 200 to 10,000) in a concentration range of about 0.01 to 5 gram/liter, and the like.

Various materials are used as the polymers, including resins according to an embodiment. In an embodiment, an epoxy is used. In an embodiment, a cyanate ester composition or the like is used. In an embodiment, a polyimide composition or the like is used. In an embodiment, a polybenzoxazole composition or the like is used. In an embodiment, a polybenzimidazole composition or the like is used. In an embodiment, a polybenzoxazole composition or the like is used. In an embodiment, a polybenzothiazole composition or the like is used. In an embodiment, a combination of any two of the compositions is used. In an embodiment, a combination of any three of the compositions is used. In an embodiment, a combination of any four of the compositions is used. In an embodiment, a combination of any five of the compositions is used. In an embodiment, a combination of any six of the compositions is used.

In an embodiment, a polybenzoxazole is used by applying it to the substrate 110, first imprinting it, and converting it to a cured polymer via either IR or microwave radiation. The radiation causes a thermally induced chemical cyclization of the polymer.

In an embodiment, a prepolymer is in non-cyclized form before it is further processed, via heating to a temperature over its T_{G}. On heating, the prepolymer begins to cyclize and thereby cure, by reacting with functional groups nearby, and in the process by releasing water molecules. This cyclization changes the prepolymer from its non-cyclized state to its cyclized state, and to different properties that are exhibited between the two states.

In an embodiment, a polybenzoxazole prepolymer is synthesized by reacting di hydroxylamines with di acids, to form a hydroxyl amide. The hydroxy amide is heated by IR or microwaves, as the first uncured upper polymer 116, for example. The heating process begins to convert the prepolymer to a closed-ring polybenzoxazole.

In an embodiment, the coefficient of thermal expansion (CTE) is about 30 part per million (ppm). In an embodiment, the thermal stability exceeds about 450° C. Generally, the polymer is substantially chemically inert and substantially insoluble after thermal processing. In an embodiment the polymer has a dielectric constant of about 2.5. After thermal processing the closed-ring polybenzoxazole has greater adhesion to metal substrates such as copper or aluminum.

In an embodiment, a poly (o-hydroxyamide) precursor is dissolved and cast as the uncured upper first polymer 116. The uncured upper first polymer 116 is in a non-cyclized state. The T_{G} of the hydroxyamide is also about 75 to 100° C. lower than the cured polymer. The hydroxyamide is next imprinted with the upper imprinting press 124 at a temperature of about 75 to 100° C. higher than the T_{G}. Embossing at this temperature range provides for sufficient flow of the uncured upper first polymer 116, but the intermediate upper first polymer 117 retains features of the imprinting press 124 at the uncured polymer surface. During thermal processing with either IR or microwave energy, conversion of uncured polymer from a poly(hydroxyamide) to a fully cyclized poly benzoxazole film occurs. The T_{G} shifts upwardly to about 75 to 100° C. higher than the uncured polymer. Next, the first metallization 132 is formed. Thereafter, a second, lower T_{G} material layer is formed as the uncured upper second polymer 140. Second imprinting can now be done at a temperature lower than the T_{G} of the cured polymer first upper film 118 because the T_{G} thereof has shifted, and at a temperature higher than the T_{G} of the uncured upper second polymer 140. Accordingly, the second heat treating achieves a significantly cyclized poly benzoxazole for the cured polymer upper second film 142, without causing the degree of planarity of the cured polymer upper first film 118 to change outside a given embodiment set forth in this disclosure.

The use of a non-cyclized polymer and its IR or microwave conversion to a significantly cyclized polymer, allows for embossing a polymer layer with lower T_{G} using the poly(hydroxamide) precursor, at an embossing temperature much higher than the T_{G} of the precursor polymer, thus transforming the T_{G} of the embossed layer to a much higher T_{G} via chemical cyclization of the poly(hydroxyamide) film to a polybenzoxazole polymer.

FIG. 3 is an elevation taken from a section in FIG. 1C according to an embodiment. In an embodiment, the cured polymer film 118 acts as a matrix for a filler material 319 that is included for thermal management. In an embodiment, the filler material 319 is a particulate such as silica or the like. In an embodiment, the filler material 319 is a particulate such as ceria or the like. In an embodiment, the filler material 319 is a particulate such as zirconia or the like. In an embodiment, the filler material 319 is a particulate such as thoria or the like. Other particulates may be used. In an embodiment, the filler material 319 is a diamond powder. In an embodiment, the filler material 319 is present in a range from about 1 percent to about one-half or greater the total weight of the cured polymer film. In an embodiment, the filler material 319 is in a range from about 2 percent to about 30 percent. In an embodiment, the filler material 319 is in a range from about 5 percent to about 25 percent. In an embodiment, the filler material 319 is in a range from about 10 percent to about 20 percent.

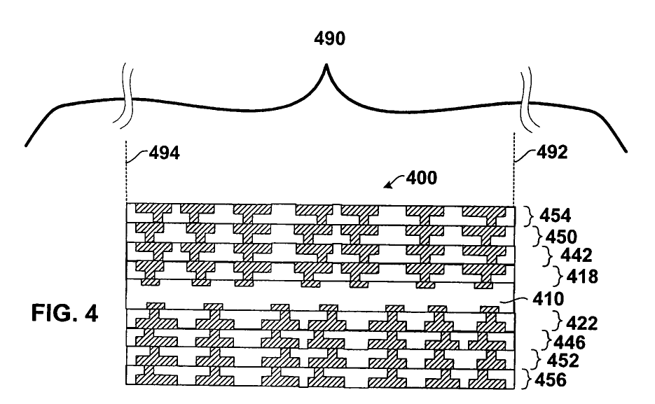

FIG. 4 is a cross-section of a structure 400 according to an embodiment. In an embodiment, two or more cured polymer films are assembled above the substrate 410. In an embodiment, the last cured polymer film 454 is referred to as a “subsequent” cured polymer film, and processing thereof is referred to as “subsequent” processing. In an embodiment, however, “subsequent” processing refers to processing of the cured polymer second film 442.

In an embodiment, a three-film structure includes the cured polymer first film 418, the cured polymer second film 442 disposed above and on the cured polymer first film 418, and a cured polymer subsequent film (in this embodiment, 450) disposed above and on the cured polymer second film 442.

In an embodiment, “subsequent” processing refers to processing of a cured polymer fourth film 454. Therefore, a four-film structure includes the cured polymer first film 418, the cured polymer second film 442 disposed above and on the cured polymer first film 418, the cured polymer third film 450 disposed above and on the cured polymer second film 442, and a cured polymer subsequent film 454 disposed above and on the cured polymer third film 450.

In an embodiment, FIG. 4 also illustrates respective metallizations for the various cured polymer films. FIG. 4 also illustrates lower films 422, 446, 452, and 456, along with their respective metallizations according to the various embodiments.

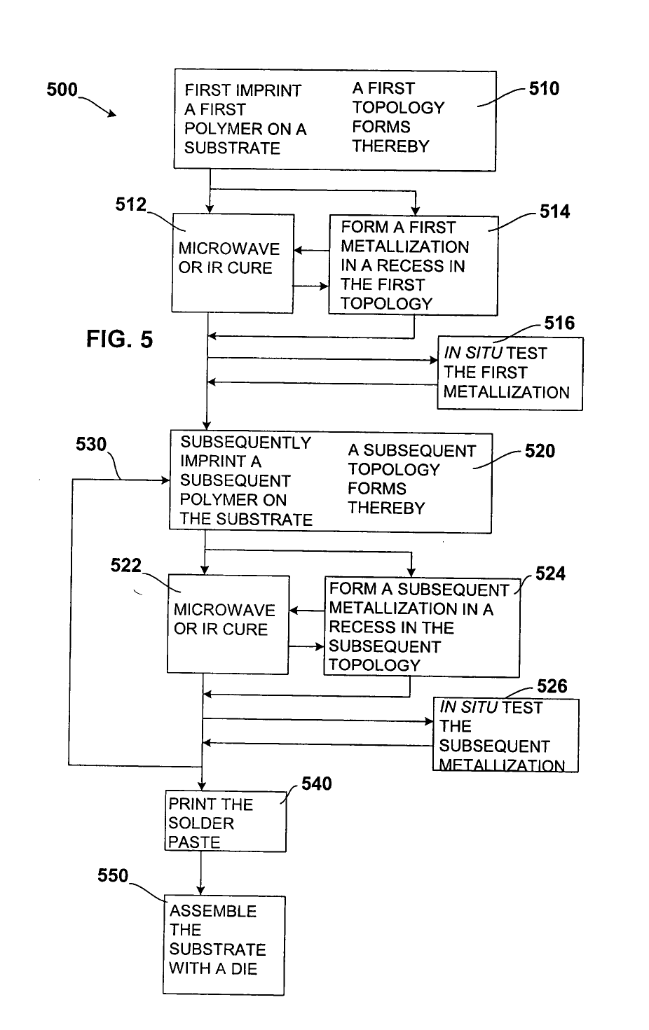

FIG. 5 is a process flow diagram 500 that illustrates various exemplary process embodiments that relate to FIGS. 1, 1A, 1B, 1C, 1D, 1E, 1F, and 1G.

At 510 an uncured first polymer is thermally first imprinted and may thereby be transformed into an intermediate first polymer.

At 512, the first intermediate polymer is first cured to form a cured polymer first film. In an embodiment the process at 512 follows the process at 514. In an embodiment, the first intermediate polymer is cured by radiant energy to form a cured polymer first film.

At 514, the first metallization is formed in a recess in the imprinted first polymer. In an embodiment the process at 512 precedes the process at 514.

At 516, the process includes in situ testing of at least one board layout in a board layout array. The in situ testing allows for rapid testing of board layouts, and avoids handling problems later in processing such as pick-and-place processing of an electronic device. In an embodiment, the process flow is completed at 516. In an embodiment, the structure 400 (FIG. 4) is depicted as part of a board layout array 490, that was segmented along the scribe lines 492 and 494.

At 520 an uncured subsequent polymer is thermally subsequently imprinted and may thereby be transformed into an intermediate subsequent polymer.

At 522, the subsequent intermediate polymer is subsequently cured to form a cured polymer subsequent film. In an embodiment the process at 522 follows the process at 524. In an embodiment, the subsequent intermediate polymer is subsequently cured by radiant energy to form a cured polymer subsequent film.

At 524, the subsequent metallization is formed in a recess in the imprinted subsequent polymer. In an embodiment the process at 522 precedes the process at 524.

At 526, the process includes in situ testing of at least one board layout in a board layout array according to an embodiment. In an embodiment, the process flow is completed at 526.

In an embodiment, the process flow returns at 530 to imprinting a subsequent polymer. In the first iteration at 530, the subsequent polymer is a third polymer.

Where the process at 500 has several iterations, the cured polymer films can be designed with decreased thicknesses. In an embodiment, the cured polymer films, or one of them is about one-tenth the thickness of the substrate. In an embodiment, the cured polymer films, or one of them is about one-eighth the thickness of the substrate. In an embodiment, the cured polymer films, or one of them is about one-fifth the thickness of the substrate. In an embodiment, the cured polymer films, or one of them is about one-fourth the thickness of the substrate. In an embodiment, the cured polymer films, or one of them is about one-third the thickness of the substrate. In an embodiment, the cured polymer films, or one of them is about one-half the thickness of the substrate.

At 540, a method embodiment includes preparing the substrate to be connected to a die. By way of non-limiting example, the substrate 110 (FIG. 1) is screen printed to form electrical bumps 12.

At 550, a microelectronic device (e.g., a die) is assembled with the substrate. By way of non-limiting example, the microelectronic device 10 mounted and electrically coupled to the structure 100.

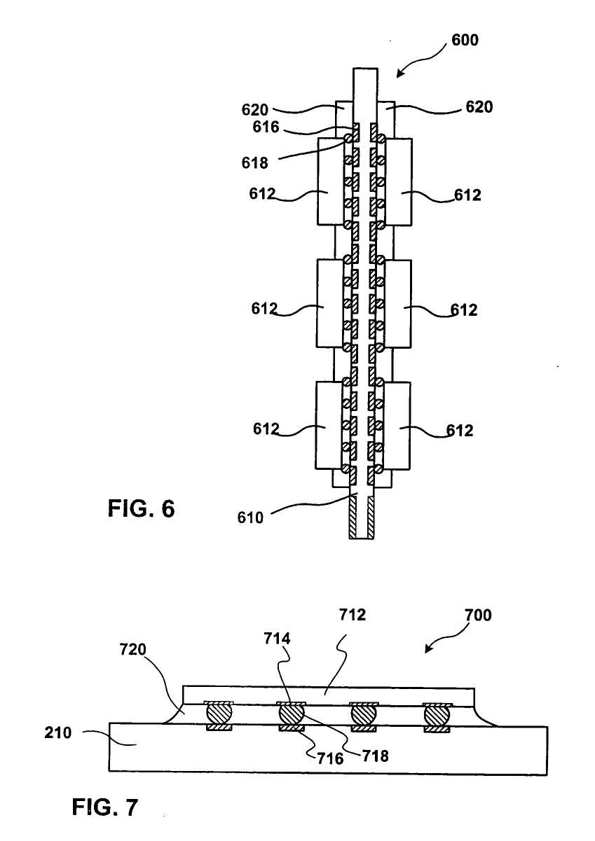

FIG. 6 is a cross-section of a package that includes the double-embossed (also referred to as the double-imprinted) substrate according to an embodiment. The package 600 includes a mounting substrate 610 that is a platform for die 612 such as a memory chip. The substrate 610 includes a double-imprinted configuration such as the substrate 110 depicted in FIG. 1. The die 612 is in a dual-in-line memory module (DIMM) configuration with respect to the mounting substrate 610. In an embodiment, only one side of the structure includes microelectronic devices, such as a single-in-line memory module (SIMM). The die 612 includes a bond pad (not pictured) that is in electrical communication with an upper second metallization 616 such as the upper second metallization 160 depicted in FIG. 1. Electrical communication is accomplished with an electrical bump 618 such as a solder ball that is juxtaposed between the die bond pad and the upper second metallization. A packaging composition 620 acts as an underfill material and as a mold compound cap material for the die 612.

FIG. 7 is a cross-section of a package that includes a double-imprinted mounting substrate according to an embodiment. The package 700 includes a mounting substrate 710 that is a platform for an IC die 712. The die 712 is in a flip-chip mounting configuration with respect to the mounting substrate 710. The die 712 includes a bond pad 714 that is in electrical communication with an upper second metallization 716 such as the upper second metallization 160 depicted in FIG. 1. Electrical communication is accomplished with an electrical bump 718 such as a solder ball.

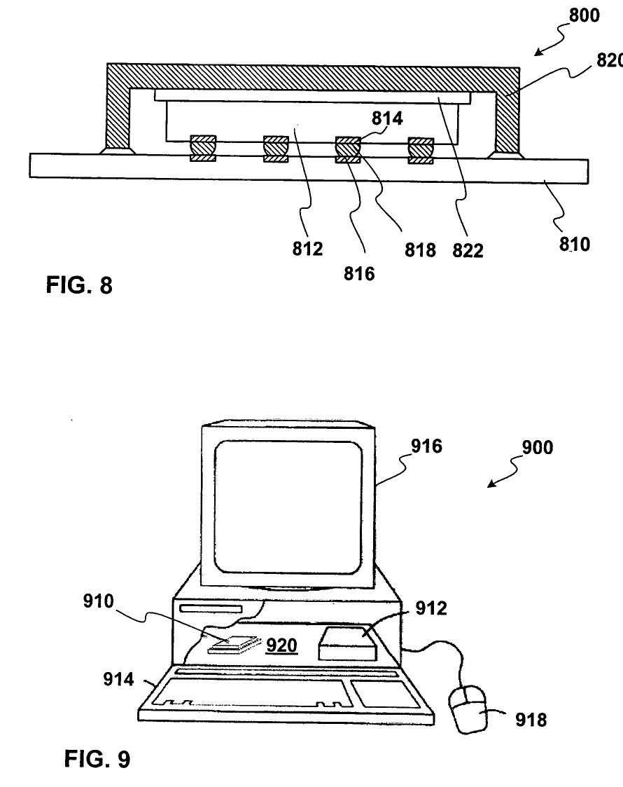

FIG. 8 is a cross-section of a package that includes a double-imprinted mounting substrate according to an embodiment. The package 800 includes a mounting substrate 810 that is a platform for an IC die 812. The die 812 is in a flip-chip mounting configuration with respect to the mounting substrate 810. The die 812 includes a bond pad 814 that is in electrical communication with an upper second metallization 816 such as the upper second metallization 160 depicted in FIG. 1. Electrical communication is accomplished with an electrical bump 818 such as a solder ball. The package includes a heat sink 820 such as in integrated heat spreader (IHS), which is also referred to a as a “lid.” The IHS 820 is bonded to the die 812 by an interface 822 that can be a medium such as a thermal grease, a reactive solder that contains indium, or a leaded solder.

FIG. 9 is a depiction of a computing system 900 according to an embodiment. One or more of the foregoing embodiments of an imprinted, IR-cured or microwave-cured substrate may be utilized in a computing system, such as a computing system 900 of FIG. 9. The computing system 900 includes at least one processor (not pictured), which is enclosed in a package 910, a data storage system 912, at least one input device such as keyboard 914, and at least one output device such as monitor 916, for example. The computing system 900 includes a processor that processes data signals, and may include, for example, a microprocessor, available from Intel Corporation. In addition to the keyboard 914, the computing system 900 can include another user input device such as a mouse 918, for example.

For purposes of this disclosure, a computing system 900 embodying components in accordance with the claimed subject matter may include any system that utilizes an imprinted substrate, which may be a mounting substrate 920, for example, for a data storage device such as dynamic random access memory, polymer memory, flash memory, and phase-change memory. The imprinted substrate can also be a mounting substrate 920 for a die that contains a digital signal processor (DSP), a micro-controller, an application specific integrated circuit (ASIC), or a microprocessor.

Embodiments set forth in this disclosure can be applied to devices and apparatuses other than a traditional computer. For example, a die can be packaged with an embodiment of the imprinted substrate and placed in a portable device such as a wireless communicator or a hand-held such as a personal digital assistant and the like. Another example is a die that can be packaged with an imprinted substrate and placed in a vehicle such as an automobile, a locomotive, a watercraft, an aircraft, or a spacecraft.

The Abstract is provided to comply with 37 C.F.R. § 1.72(b) requiring an Abstract that will allow the reader to quickly ascertain the nature and gist of the technical disclosure. It is submitted with the understanding that it will not be used to interpret or limit the scope or meaning of the claims.

In the foregoing Detailed Description, various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment.

It will be readily understood to those skilled in the art that various other changes in the details, material, and arrangements of the parts and method stages which have been described and illustrated in order to explain the nature of this invention may be made without departing from the principles and scope of the invention as expressed in the subjoined claims.

1. A process comprising:
first forming an imprinted first polymer disposed upon a substrate under conditions to increase the glass transition temperature (T_{G}) of the first polymer; and
subsequently thermal curing an imprinted subsequent polymer disposed over the first polymer.

2. The process of claim 1, before subsequently thermal curing, the process further including:
subsequently thermal imprinting the subsequent polymer, under conditions to increase the T_{G} of the second polymer.

3. The process of claim 1, wherein subsequently thermal curing includes a single thermal cure, selected from mircrowave radiation, infrared radiation, and convection.

4. The process of claim 1, wherein first forming an imprinted first polymer exposes a portion of the substrate.

5. The process of claim 1, wherein first forming an imprinted first polymer exposes a portion of the substrate to form a first topology, further including:
forming a first metallization within a recess in the first topology.

6. The process of claim 1, wherein subsequently thermal curing is carried out under conditions to heat the subsequent polymer at a greater rate than the substrate.

7. The process of claim 1, further including:
first imprinting the first polymer to form a first topology, wherein first imprinting exposes a portion of the substrate; and
subsequently imprinting the subsequent polymer to form a second topology, wherein the second topology exposes a portion of the first polymer.

8. The process of claim 1, further including:
first imprinting the first polymer to form a first topology, wherein first imprinting exposes a portion of the substrate;
forming a first metallization within a recess in the first topology;
subsequently thermal imprinting the subsequent polymer to form a second topology, under conditions to increase the T_{G} of the second polymer, wherein the second topology exposes a portion of the first polymer; and
forming a subsequent metallization within a recess in the subsequent topology.

9. The process of claim 1, wherein the substrate includes an upper surface and a lower surface, wherein the first polymer is disposed upon the upper surface, wherein the first polymer includes a cured polymer upper first film, wherein the second polymer includes a cured polymer upper second film, and upon the lower surface, the process further including:
first thermal curing a lower first polymer under conditions to heat the lower first polymer at greater rate than the substrate; and
subsequently thermal curing an imprinted subsequent lower polymer disposed over the lower first polymer.

10. The process of claim 1, wherein the first polymer is formed over the substrate by depositing a prepolymer selected from a resin, a cyanate ester, a polyimide, a polybenzoxazole, a polybenzimidazole, a polybenzothiazole, and combinations thereof.

11. The process of claim 1, wherein the cured polymer first film includes a film-to-substrate thickness ratio selected from about one-tenth, one-eighth, one-fifth, one-fourth, one-third, and one-half the thickness of the substrate.

12. The process of claim 1, wherein the first polymer is formed over the substrate by depositing a prepolymer selected from a resin, a cyanate ester, a polyimide, a polybenzoxazole, a polybenzimidazole, a polybenzothiazole, and combinations thereof, and wherein the cured polymer first film includes a film-to-substrate thickness ratio selected from about one-tenth, one-eighth, one-fifth, one-fourth, one-third, and one-half the thickness of the substrate.

13. The process of claim 1, further including:
in situ testing the substrate while attached as part of an array of substrates.

14. A process comprising:
first forming an imprinted first polymer disposed upon a substrate under conditions to increase the glass transition temperature (T_{G}) of the first polymer;
second forming an imprinted second polymer upon the imprinted first polymer to form a second topology including a second recess; and
subsequently thermal curing the imprinted subsequent polymer disposed over the first polymer, wherein subsequently thermal curing forms a cured polymer upper first film from the imprinted first polymer and a cured polymer upper second film from the imprinted second polymer.

15. The process of claim 14, before second forming, further including:
forming a first conductive material in the first recess; and
forming a second conductive material in the second recess.

16. The process of claim 14, further including:
forming a first conductive material in the first recess, wherein forming a first conductive material is selected from blanket depositing and electroless plating; and after second curing
forming a second conductive material in the second recess, wherein forming a second conductive material is selected from blanket depositing and electroless plating.

17. The process of claim 14, wherein the first polymer is formed over the substrate by depositing a prepolymer selected from a resin, a cyanate ester, a polyimide, a polybenzoxazole, a polybenzimidazole, a polybenzothiazole, and combinations thereof.

18. The process of claim 14, wherein the cured polymer first film is in a film-to-substrate thickness ratio selected from about one-tenth, one-eighth, one-fifth, one-fourth, one-third, and one-half the thickness of the substrate.

19. The process of claim 14, wherein the first polymer is formed over the substrate by depositing a prepolymer selected from a resin, a cyanate ester, a polyimide, a polybenzoxazole, a polybenzimidazole, a polybenzothiazole, and combinations thereof, and wherein the cured polymer first film is in a film-to-substrate thickness ratio selected from about one-tenth, one-eighth, one-fifth, one-fourth, one-third, and one-half the thickness of the substrate.

20. The process of claim 14, wherein subsequently thermal curing is carried out under conditions to heat the first polymer at greater rate than the substrate.

21. A method comprising:
assembling a die to a mounting substrate, wherein the mounting substrate includes:
a first thermally imprinted cured polymer first film disposed upon a substrate; and
a subsequently thermally imprinted cured polymer subsequent film disposed over the first cured polymer first film.

22. The method of claim 21, wherein assembling a die to a mounting substrate is selected from assembling a processor to a mother board, assembling a processor to a mezzanine board, assembling a processor to an expansion card, assembling a memory chip to a board, assembling a digital signal processor to a board, assembling a micro-controller to a board, assembling an application specific integrated circuit to a board, and combinations thereof.

23. The method of claim 21, wherein the cured polymer first film includes a first topology that exposes a portion of the substrate, wherein a first metallization is disposed within a recess in the first topology; wherein the cured polymer second film includes a second topology, wherein a subsequent metallization is disposed within a recess in the subsequent topology, the method further including:
forming an electrical bump in contact with the subsequent metallization; and
coupling the electrical bump with the die.

24. The method of claim 21, wherein the first thermally imprinted polymer is imprinted under conditions to increase the glass transition temperature (T_{G}) of the first polymer, and wherein the subsequently thermally imprinted polymer is imprinted under conditions to increase the T_{G} of the subsequent polymer.

25. An intermediate system comprising:
a substrate at a substrate temperature;
a cured polymer first film at a first glass transition temperature (T_{G}); and
an intermediate polymer second film at a second T_{G}, wherein the cured polymer second film is disposed above and on at least a portion of the cured polymer first film, and wherein the second T_{G} is less than the first T_{G}.

26. The intermediate system of claim 25, wherein the cured polymer first film is selected from a resin, a cyanate ester, a polyimide, a polybenzoxazole, a polybenzimidazole, a polybenzothiazole, and combinations thereof.

27. The intermediate system of claim 25, wherein the cured polymer first film is in a film-to-substrate thickness ratio selected from about one-tenth, one-eighth, one-fifth, one-fourth, one-third, and one-half the thickness of the substrate.

28. A structure comprising:
a substrate;
a cured polymer first film disposed above the substrate, wherein the cured polymer first film exhibits a first topology, and a minimum feature within the first topology, and wherein the minimum feature exhibits a deviation from planarity of 10 percent or less; and
a cured polymer second film disposed above and on the cured polymer first film, wherein the cured polymer second film exhibits a second topology.

29. The structure of claim 28 further including:
an electronic device electrically coupled to the structure.

30. The structure of claim 28, further including:
an electronic device electrically coupled to the structure, wherein the structure is disposed in one of a computer, a wireless communicator, a hand-held device, an automobile, a locomotive, an aircraft, a watercraft, and a spacecraft.
